(19) United States
(12) Patent Application Publication
(10) Pub. No.: US 2016/0162820 A1
(43) Pub. Date: Jun. 9, 2016

(54) Governance, Risk, and Compliance (GRC) Cloud Services

(71) Applicants: Viktor Povalyayev, Santa Clara, CA (US); Senthil Chinnathambi, Fremont, CA (US); David Hu, Palo Alto, CA (US); Lata Krishnamohan, Saratoga, CA (US)

(72) Inventors: Viktor Povalyayev, Santa Clara, CA (US); Senthil Chinnathambi, Fremont, CA (US); David Hu, Palo Alto, CA (US); Lata Krishnamohan, Saratoga, CA (US)

(21) Appl. No.: 14/565,281

(22) Filed: Dec. 9, 2014

(51) Int. Cl. G06Q 10/06; H04L 29/08

(52) U.S. Cl. CPC G06Q 10/0635; H04L 67/02; H04L 67/16

(57) ABSTRACT

Governance, risk, and compliance (GRC) functionality is implemented in a cloud environment utilizing logic provided by a function library that is present within an underlying in-memory database layer. In some embodiments, the GRC logic of the in-memory database function library is expressed in a language (e.g., C++) agnostic to that of an overlying application layer(s). In other embodiments, the in-memory database function library may be expressed in a specialized application code (e.g., ABAP of SAP SE) that is utilized by an application/application layer designed to interact with the in-memory database (e.g., HANA of SAP SE). In such embodiments the logic of the function library may be consumed (e.g. by the in-memory database engine) utilizing a function afforded by that specialized language. Particular embodiments may check for Segregation of Duties (SoD) violations based upon user and risk information input to the system.

### BACKGROUND

Embodiments relate to governance, risk, and compliance (GRC) services, and in particular, to implementing such services in a cloud environment. Unless otherwise indicated herein, the approaches described in this section are not prior art to the claims in this application and are not admitted to be prior art by inclusion in this section.

Governance, risk, and compliance describes potentially related activities such as corporate governance, Enterprise Risk Management (ERM), and corporate compliance with applicable laws and regulations. Such GRC efforts have become increasingly complex as companies move to expand internationally into many individual jurisdictions, each having different governing law systems.

GRC applications may reference a variety of types of data stored in an underlying database (DB) and organized into data structures. A conventional GRC database comprises disk-type storage, with the logic responsible for implementing GRC functions on that data, coded in an application layer overlying the database. While suited for on-premises applications where a local database comprises regional GRC data, such disk-based DB approaches may be difficult to apply in a scaled manner for cloud-type solutions where access may be needed from locations spanning wide geographic areas.

### SUMMARY

Governance, risk, and compliance (GRC) functionality is implemented in a cloud environment utilizing logic provided by a function library that is present within an underlying in-memory database layer. In some embodiments, the GRC logic of the in-memory database function library is expressed in a language (e.g., C++) agnostic to that of an overlying application layer(s). In other embodiments, the in-memory database function library may be expressed in a specialized application code (e.g., ABAP of SAP SE) that is utilized by an application/application layer designed to interact with the in-memory database (e.g., HANA of SAP SE). In such embodiments the logic of the function library may be consumed (e.g. by the in-memory database engine) utilizing a function afforded by that specialized language. Embodiments may leverage the processing power available to an in-memory database in order to implement GRC functionality within a cloud-type environment. Particular embodiments may check for Segregation of Duties (SoD) violations based upon user and risk information input to the system.

An embodiment of a computer-implemented method comprises providing an in-memory database layer comprising a matching engine, a function library, and a database including governance, risk, and compliance (GRC) data. The matching engine receives an input regarding an action to be taken by an employee. The matching engine processes the GRC data according to the input and the functional library to generate a report including a violation. The in-memory database layer communicates the report to a web browser.

A non-transitory computer readable storage medium embodies a computer program for performing a method comprising providing an in-memory database layer comprising a matching engine, a function library, and a database including governance, risk, and compliance (GRC) data. The matching engine receives an input regarding an action to be taken by an employee. The matching engine processes the GRC data according to the input and the functional library to generate a report including a violation. The in-memory database layer communicates the report to a web browser.

An embodiment of a computer system comprises one or more processors and a software program executable on said computer system. The software program is configured to provide an in-memory database layer comprising a matching engine, a function library, and a database including governance, risk, and compliance (GRC) data. The software program is configured to cause the matching engine to receive an input regarding an action to be taken by an employee. The software program is configured to cause the matching engine to process the GRC data according to the input and the functional library to generate a report including a violation. The software program is configured to cause the in-memory database layer to communicate the report to a web browser.

In certain embodiments the function library is coded in a language not specific to an application layer configured to interact with an in-memory database layer.

In some embodiments the language comprises C++.

In particular embodiments the function library is coded in a language specific to an application layer configured to interact with the in-memory database layer.

According to various embodiments the function library causes the matching engine to operate utilizing a function provided by the language.

In various embodiments the input comprises risk information and user information.

According to certain embodiments the risk information further comprises an action component and a permission component.

In some embodiments the violation comprises a conflict of interest based upon Separation of Duties (SoD).

The following detailed description and accompanying drawings provide a better understanding of the nature and advantages of embodiments.

### BRIEF DESCRIPTION OF THE DRAWINGS

FIG. 1 is a simplified view of a system configured to provide GRC functionality according to an embodiment.

FIG. 2 is a simplified view of a process flow according to an embodiment.

FIG. 3 is a simplified view of one example of an architecture for implementing cloud-based GRC functionality according to an embodiment.

FIG. 3A shows a detailed view of the architecture of FIG. 3.

FIGS. 3B1-3B8 provide code written in the C++ language for performing a matching function.

FIGS. 3C1-3C8 provide code written in the ABAP language for performing a matching function.

FIG. 4 shows a simplified view of a portion of a process flow of a matching engine of FIG. 3A performing Segregation of Duties (SoD) functionality according to an embodiment.

FIG. 5 shows a simplified view of a remaining portion of a process flow of a matching engine.

FIG. 6 is a detailed process flow according to an embodiment.

FIGS. 7-7C2 illustrate various aspects of an example of a user interface for a cloud GRC system according to an embodiment.

FIG. 8 illustrates hardware of a special purpose computing machine configured to provide GRC functionality according to an embodiment.

FIG. 9 illustrates an example of a computer system.

### DETAILED DESCRIPTION

Described herein are techniques for implementing GRC activities in a cloud-based environment. In the following description, for purposes of explanation, numerous examples and specific details are set forth in order to provide a thorough understanding of the present invention. It will be evident, however, to one skilled in the art that the present invention as defined by the claims may include some or all of the features in these examples alone or in combination with other features described below, and may further include modifications and equivalents of the features and concepts described herein.

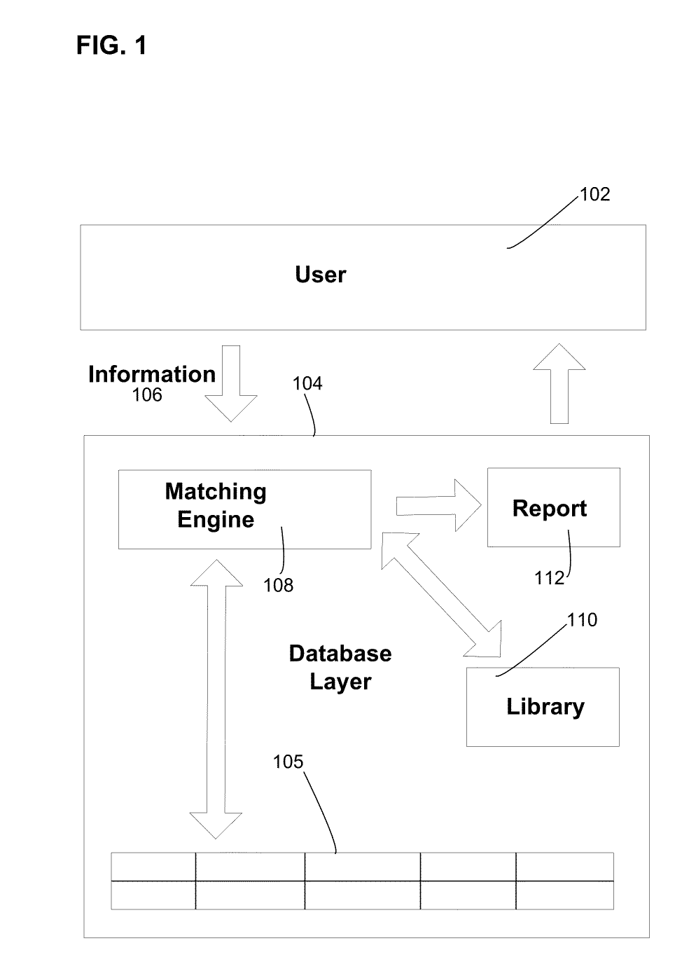

FIG. 1 shows a simplified view of a system 100 according to an embodiment. Specifically, user 102 (e.g., a manager) is in communication with a database layer 104 comprising stored data 105 relevant to GRC functionality. In certain embodiments, this stored data may be in the form of table(s) comprising rows and columns.

The manager provides information 106 relating to GRC, to the database layer. In an example, this information may comprise an identity of the manager's employee, an action the employee seeks to take within the enterprise (e.g., to make a payment to a vendor), and the existence of any permissions granted to the employee to take the action.

A matching engine 108 within the database layer receives this information from the manager. In certain embodiments, this matching engine used for GRC analysis, may be same engine already available to the in-memory database (e.g., the HANA in-memory database engine). Such embodiments may thus leverage existing processing power in order to rapidly and efficiently perform GRC functions.

The engine then processes that information according to a library 110 of stored functions. These stored functions within the library are designed to implement specific GRC tasks.

Thus continuing with the example just given, one of the stored functions of the library may check to see whether permissions and authorizations of a user and his role(s) in the organization are in compliance with security regulations such as the United States Sarbanes-Oxley Act (SoX). Accordingly, the system may check to see whether the employee who is now seeking to make payment to a vendor, is the same employee who originally established the enterprise-vendor relationship.

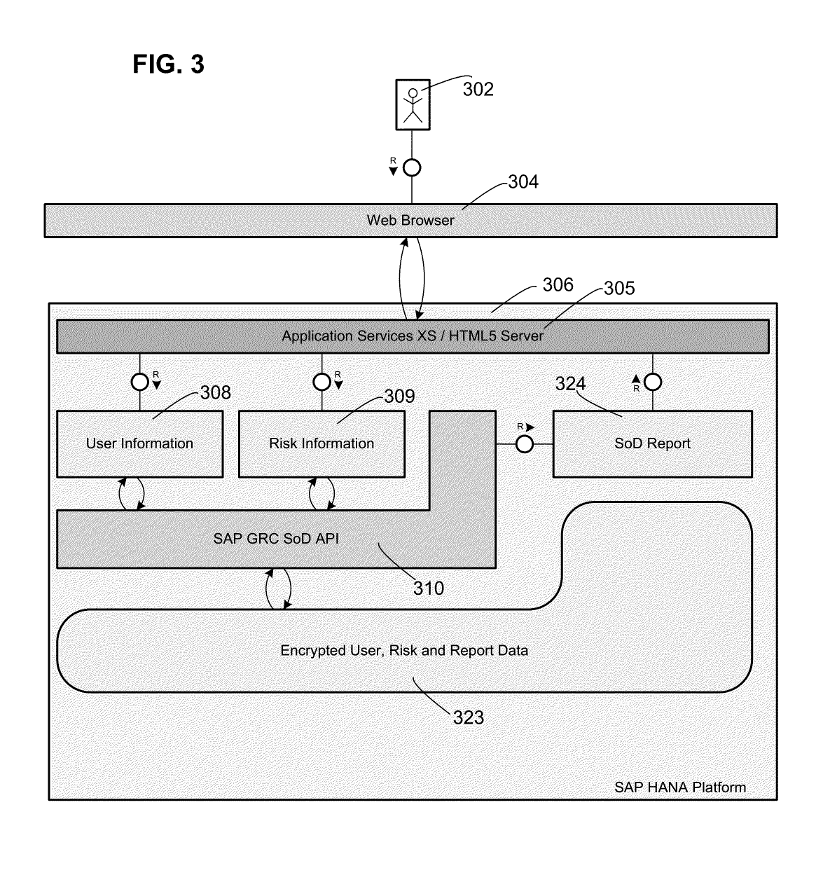

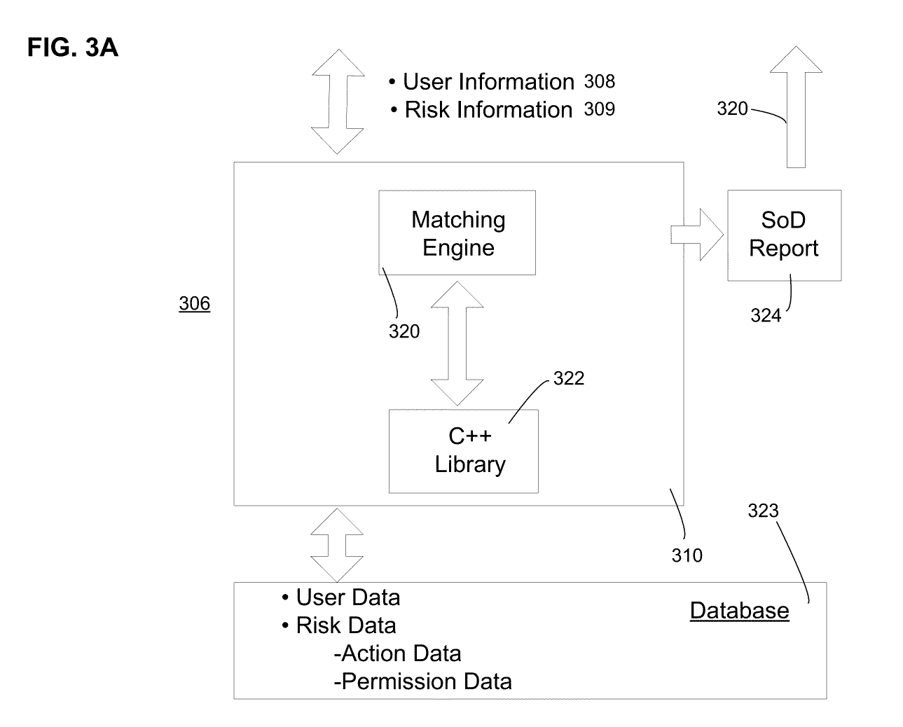

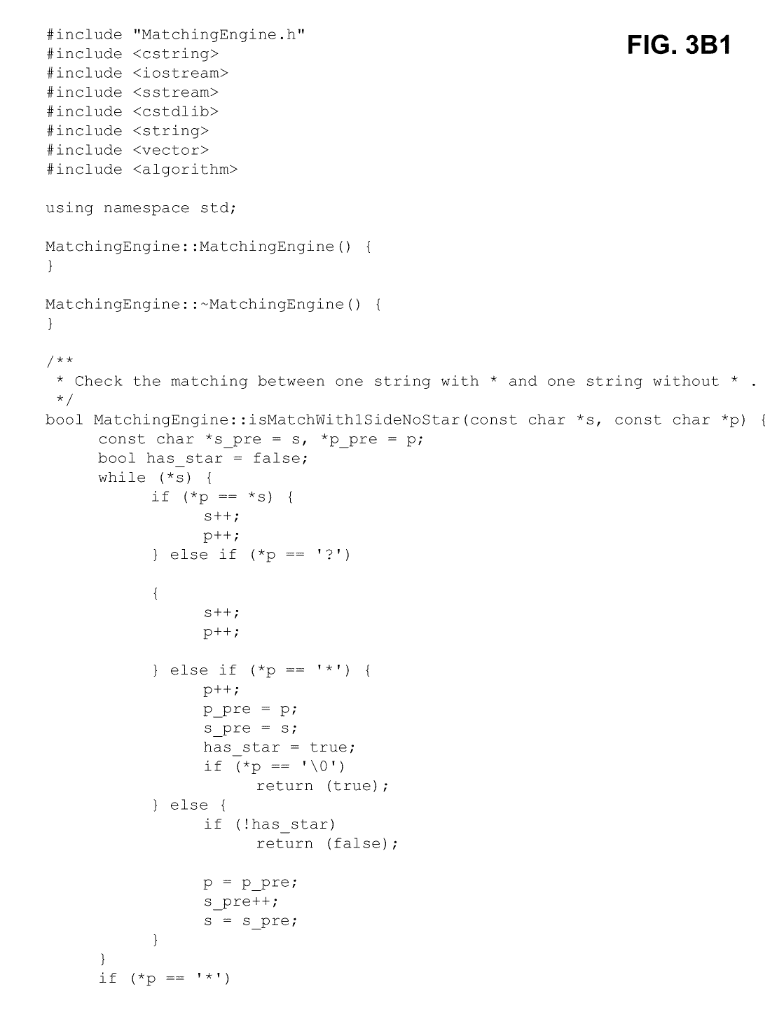

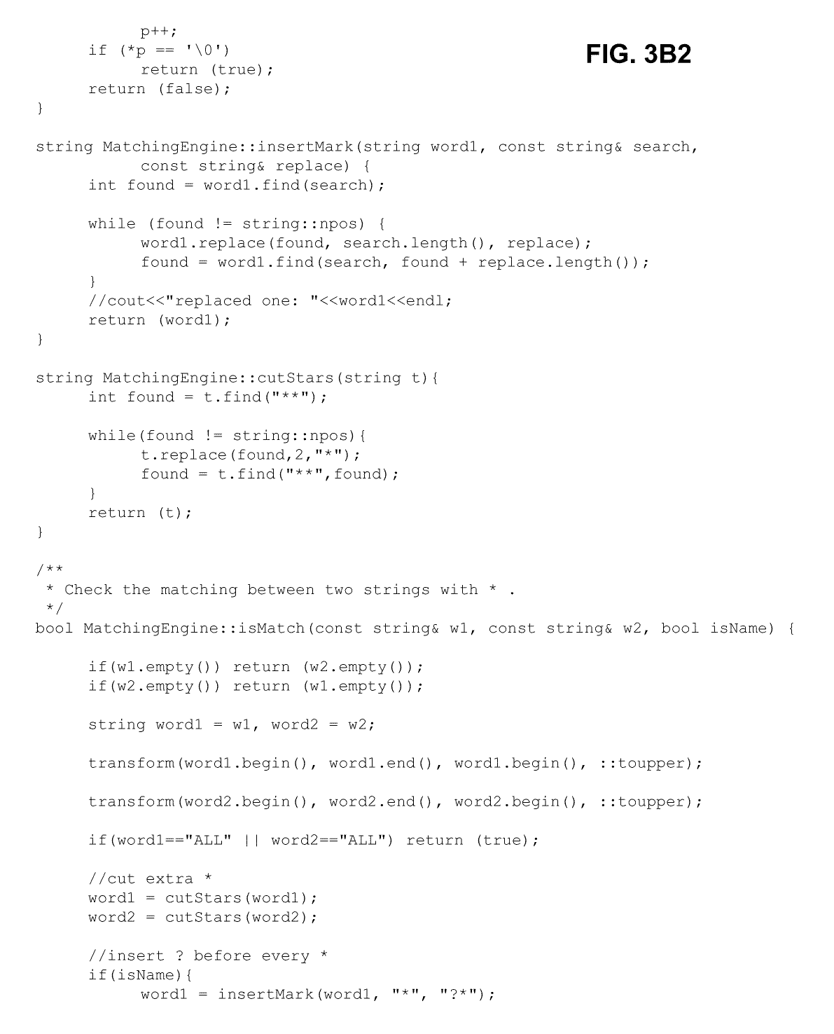

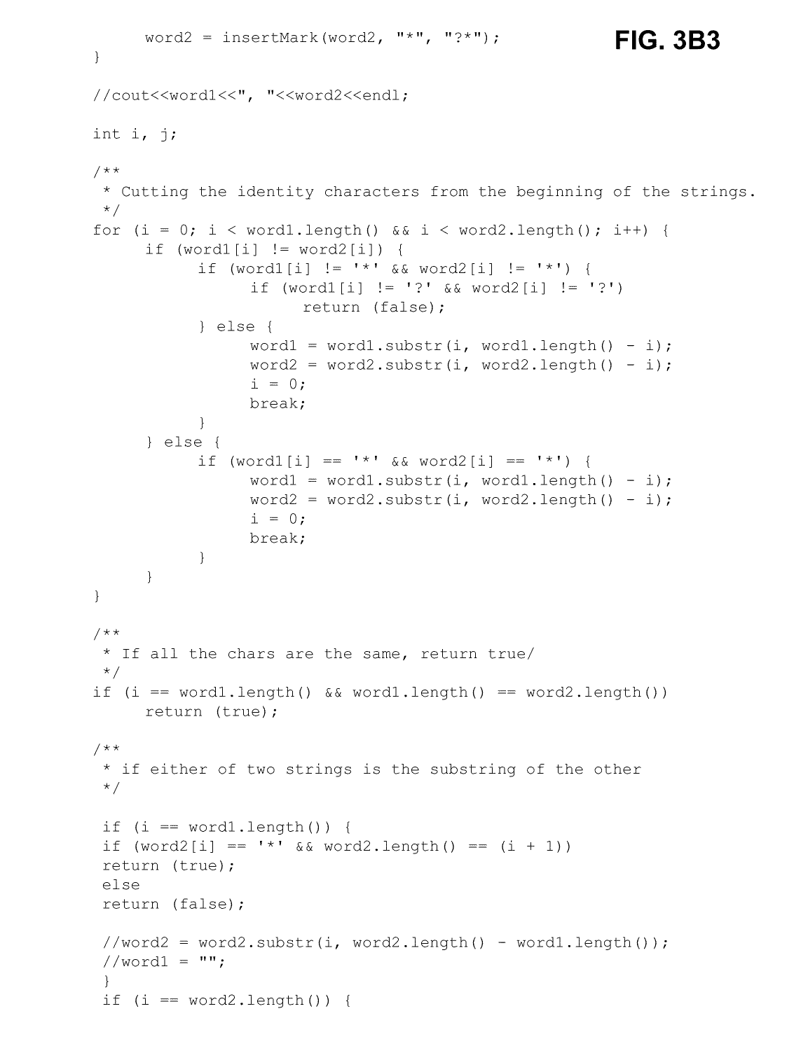

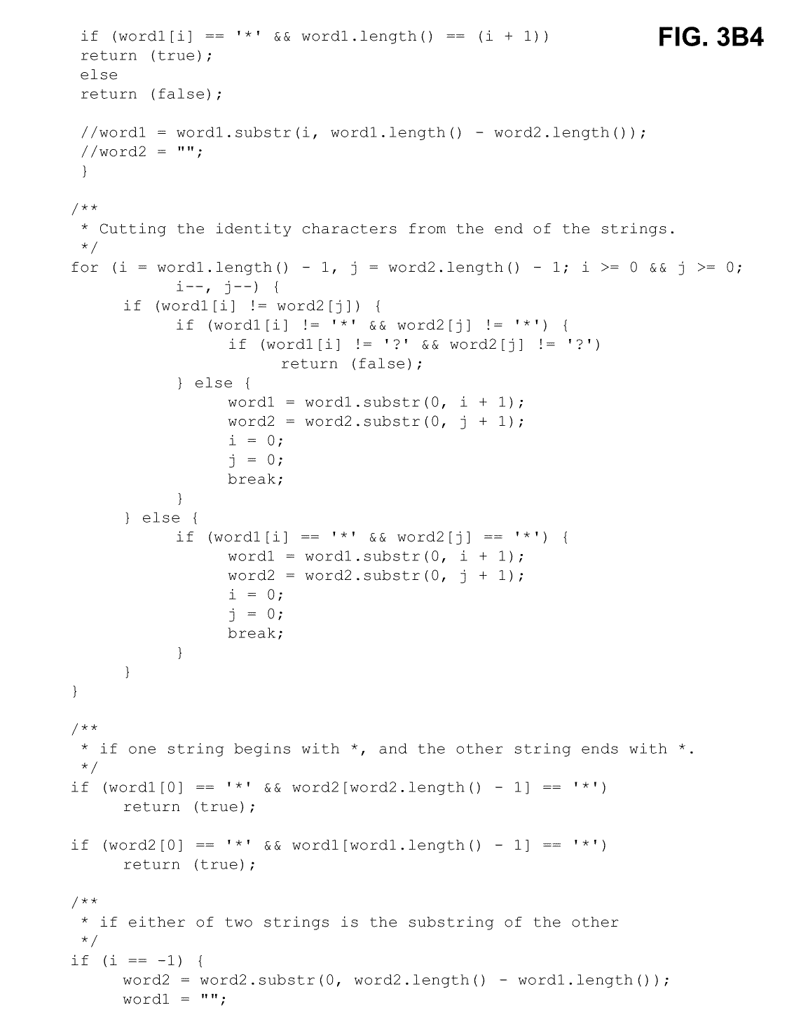

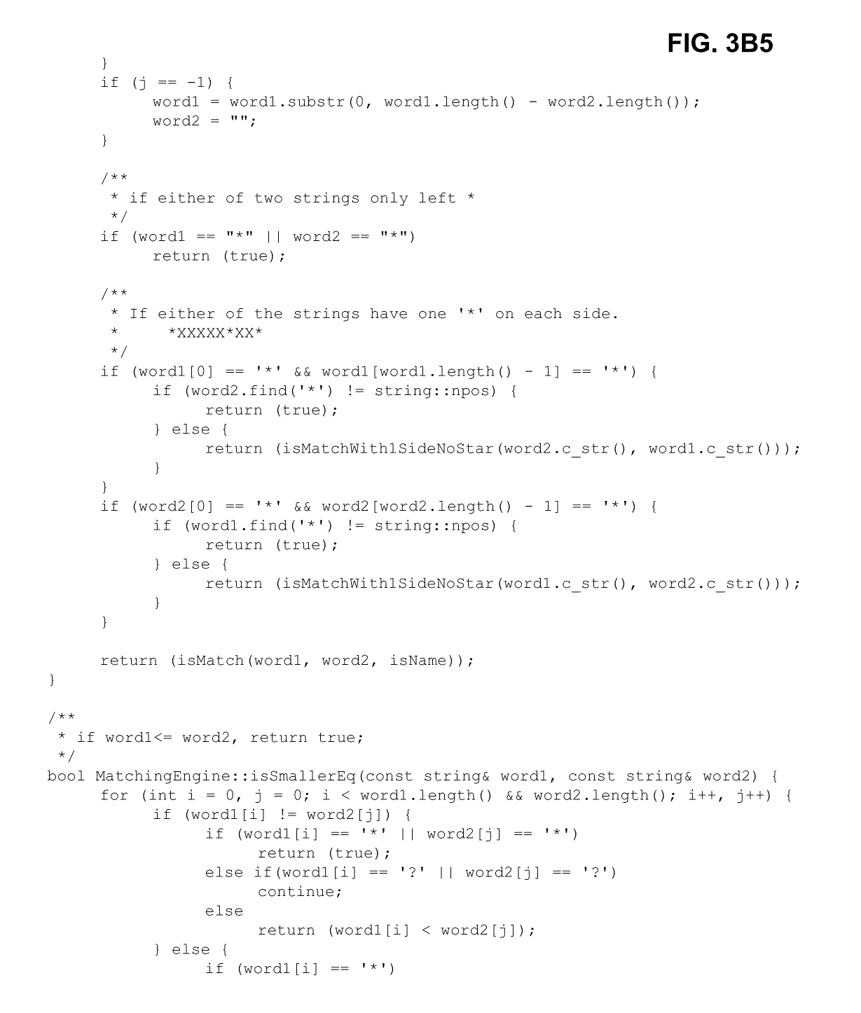

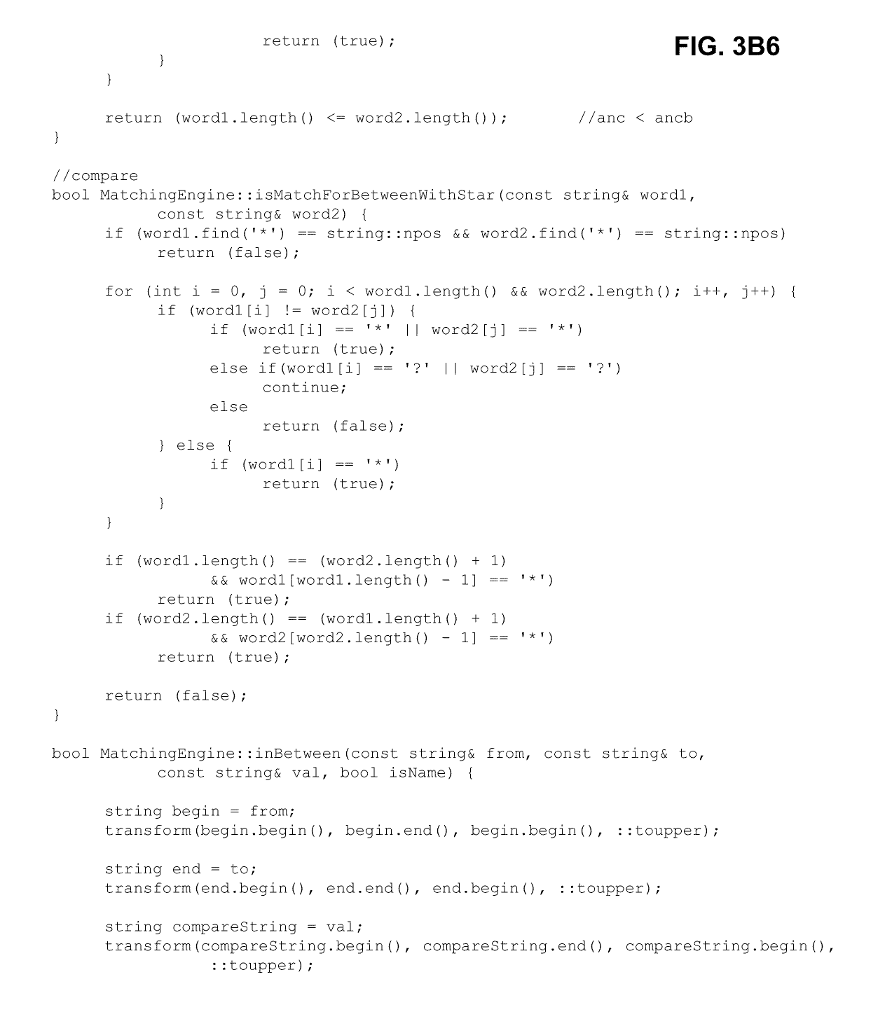

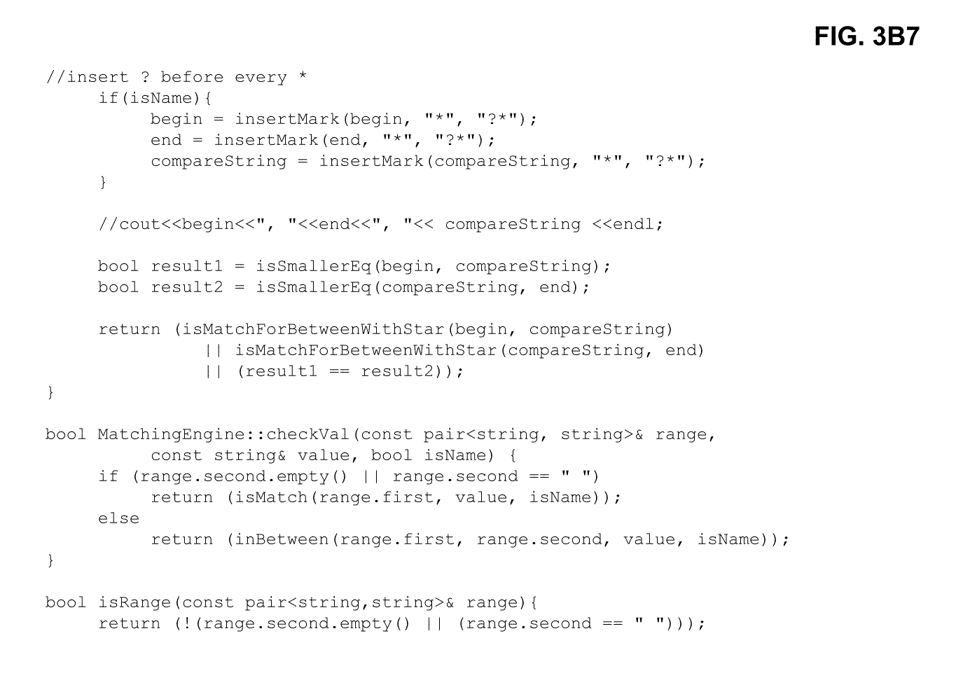

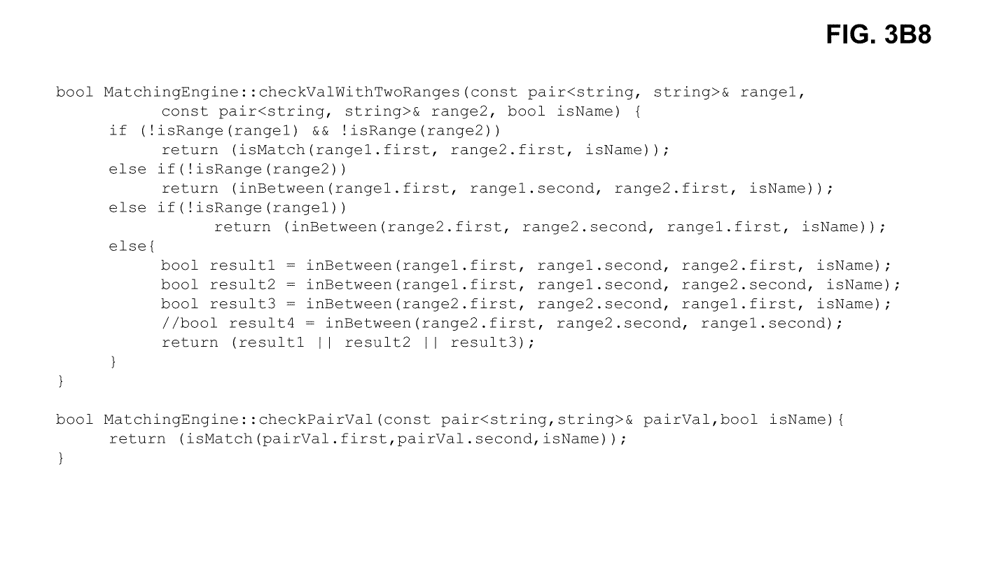

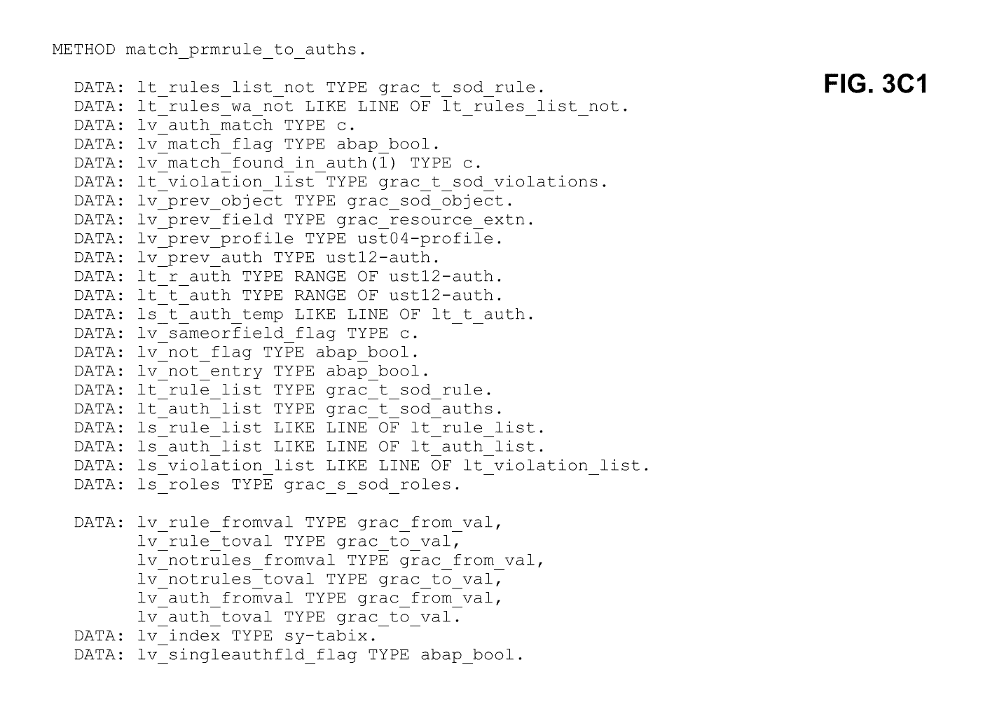

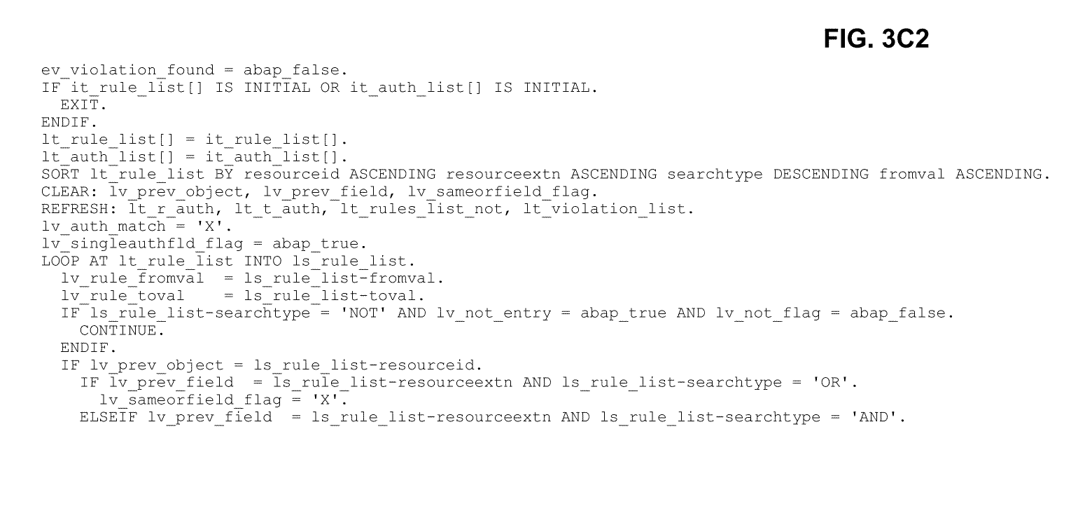

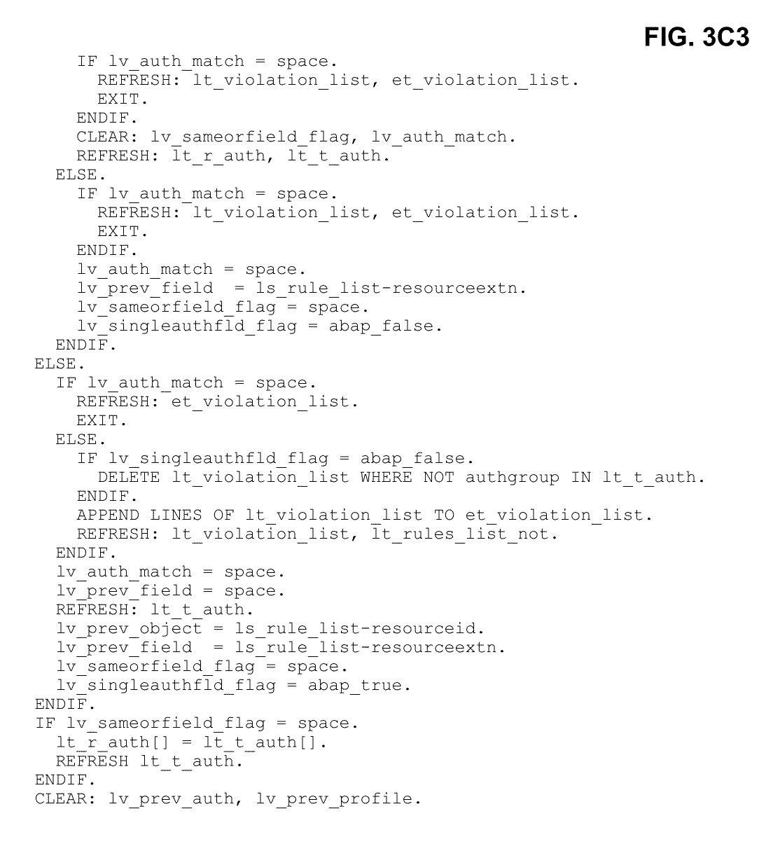

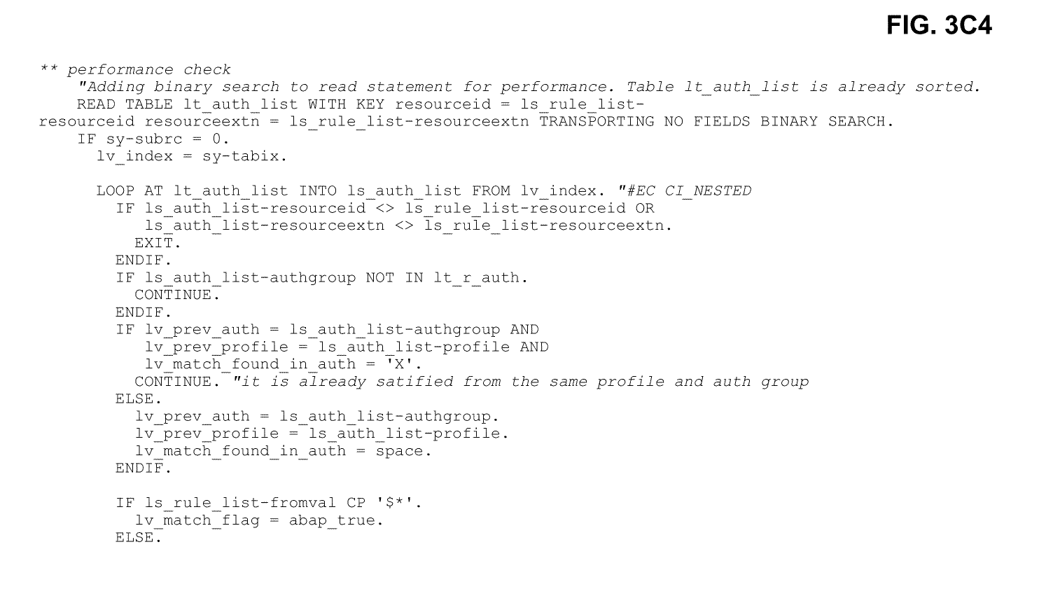

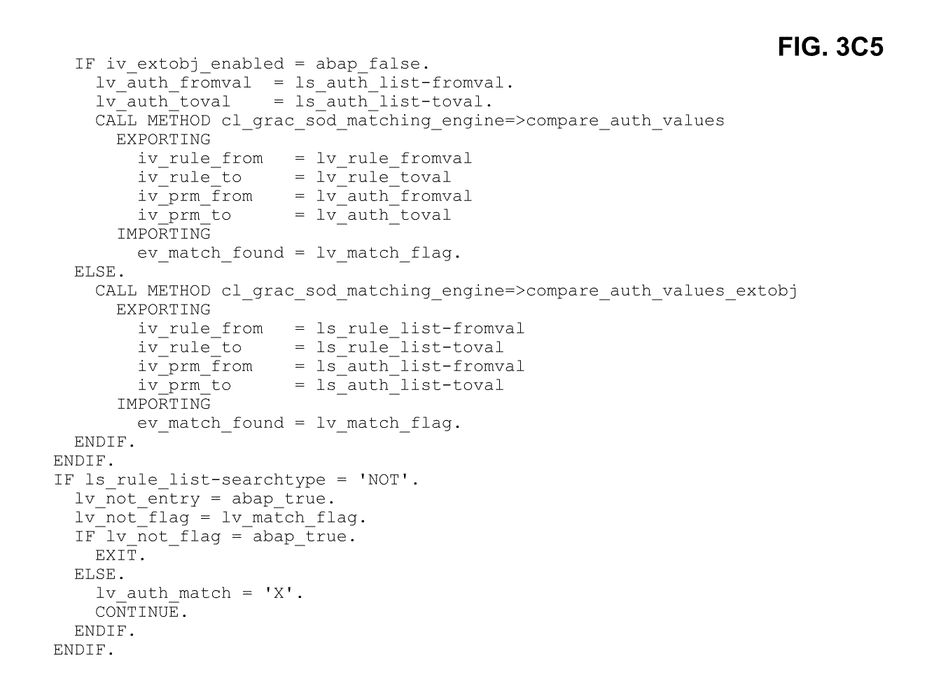

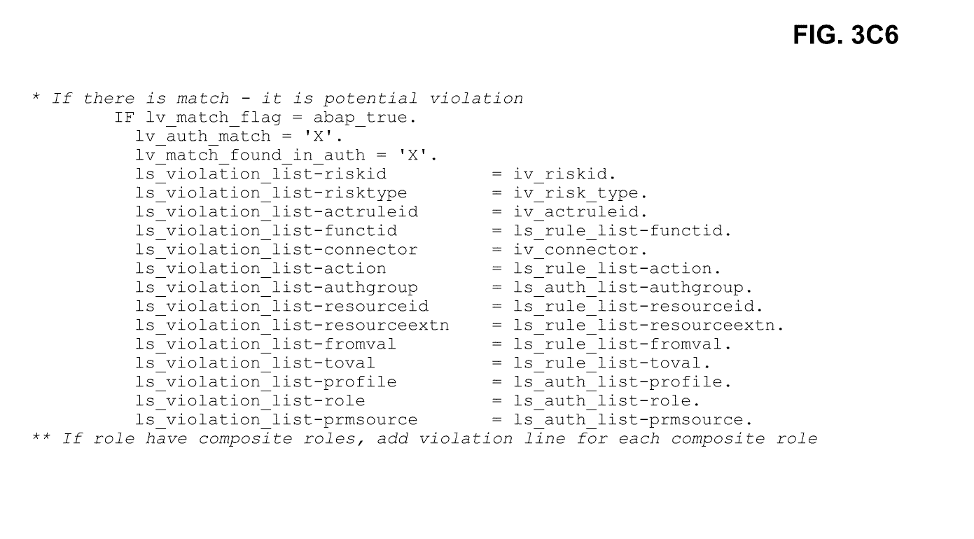

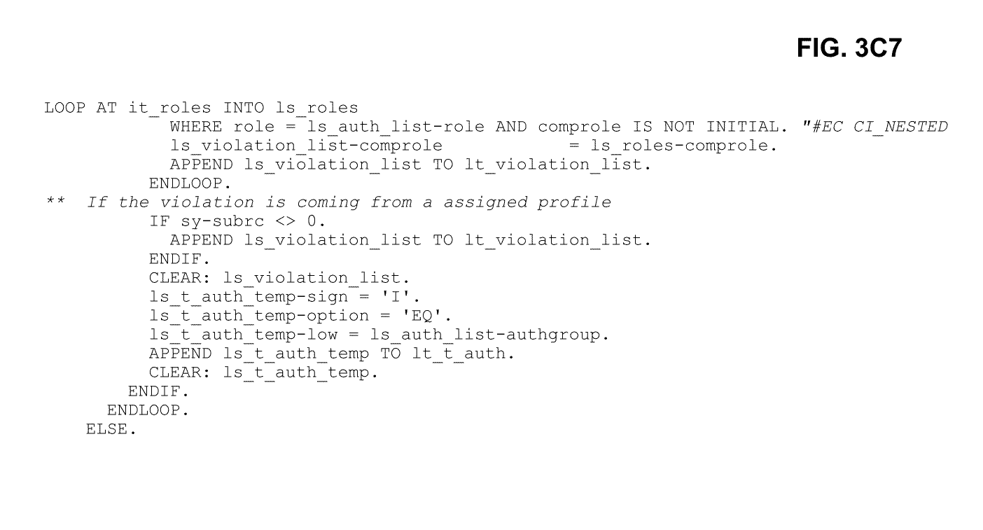

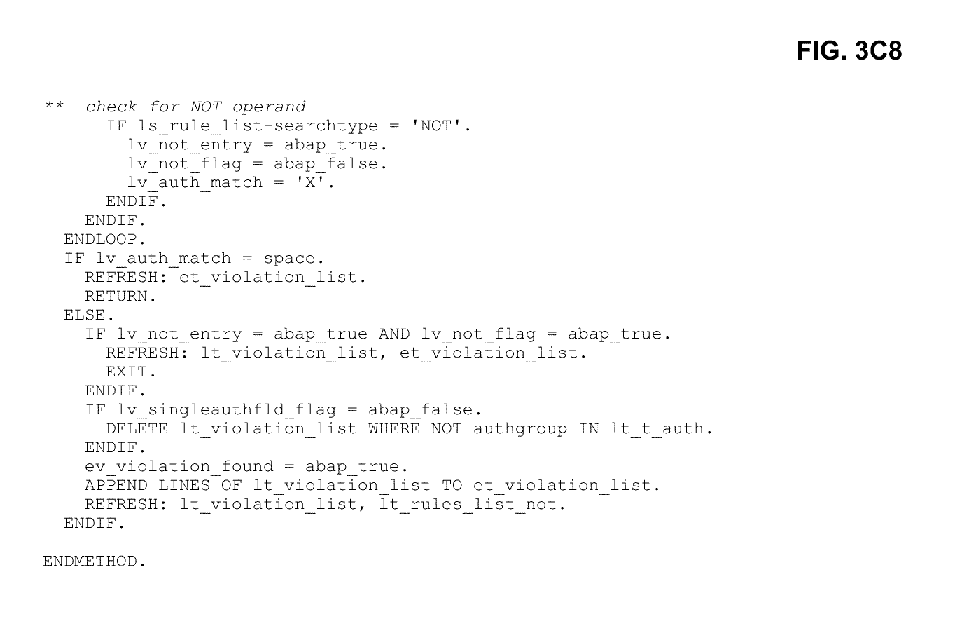

If the employee seeking to pay the vendor is the same one who originally engaged with that vendor, then a conflict of interest may be indicated to have arisen in violation of Segregation of Duty (SoD) principles. Details regarding SoD are described below in connection with the example of FIGS. 3-7C2.

Based upon the processing of the input information and the database data according to the function library, a GRC report 112 is created. Continuing with the simple example, the GRC report may specifically flag a violation of SoD principles based upon the conflict of interest detected by applying the functional library to the database data. That is, the payee of the enterprise is discovered to be the same person who originally established the relationship with that vendor.

Once created, this GRC report reflecting the SoD violation, is then communicated back to the manager for assessment. Based upon implementation of the GRC functionality as a cloud service, it is not required to be run on a specific, local application. Rather, GRC is provided as a service consumed by a customer, and is thus location- and device-agnostic.

Thus the manager is not required to be in any specific geographic location to receive the report, and in fact may access it far away from the enterprise's premises (e.g., on a mobile device). In this simple example, based upon the report indicating violations, the manager may act to deny the employee's request to engage the prospective vendor.

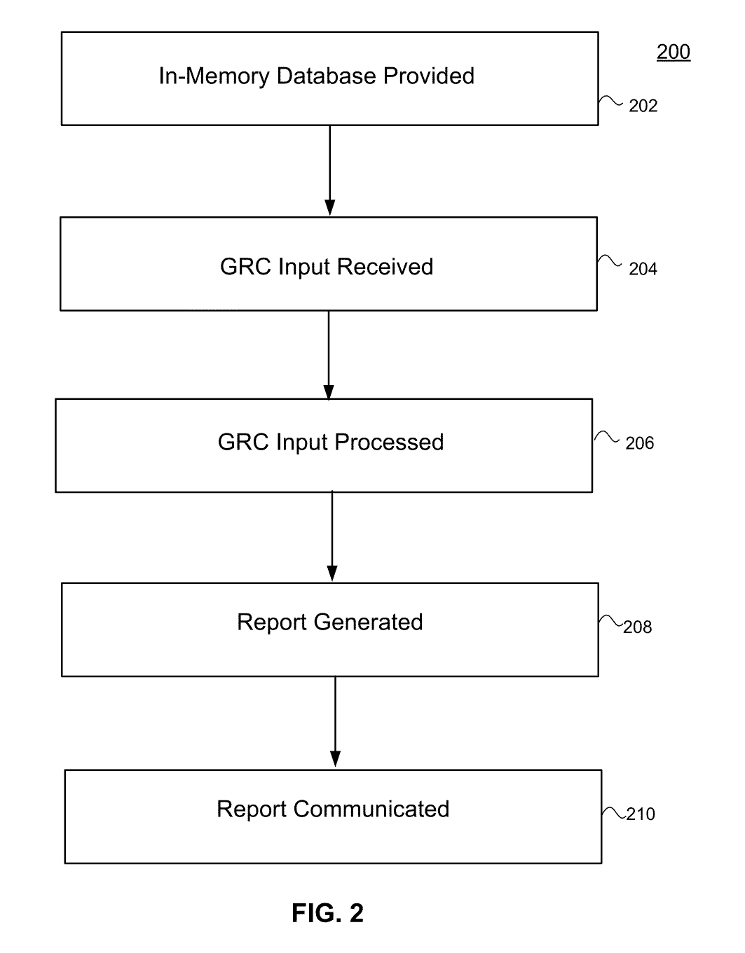

FIG. 2 is a simplified flow diagram illustrating an embodiment of a process 200 according to an embodiment. In a first step 202, an in-memory database layer is provided including a matching engine, a function library, and a database comprising governance, risk, and compliance (GRC) data.

In a second step 204, the matching engine receives input relating to an employee seeking to perform an act. In a third step 206, the matching engine processes the GRC data stored in the database according to the input information and the function library.

In a fourth 208, based upon the processing, the matching engine generates a report indicating at least one Governance, Risk, and Compliance (GRC) violation. In a fifth step 210, a server of the in-memory database layer communicates this report to a remote web browser.

Details providing further explanation of various embodiments are now described in connection with a specific example. This particular example shows implementation of GRC functionality in a cloud environment utilizing the HANA in-memory database platform available from SAP SE of Walldorf, Germany.

### Example

As described herein, GRC functions which may be implemented via the cloud, can take many forms. One specific type of GRC functionality controls an ability of individual employees to assume certain roles within an organization, and to perform certain actions.

Such access control can provide access-risk analysis. In particular, cloud-based implementation of SoD and critical access violations may be accurately identified and remediated in near-real time.

Specifically, the principle of Separation of Duties (SoD) describes dividing key steps amongst different employees in order to help prevent fraud that could take place if one person did all the tasks. SoD is a preventative control that foresees potential conflicts of interest. It may be used, for example, to ensure that no one person can establish a vendor relationship and then make a payment to that vendor.

SoD involves dividing up job functions so that a likelihood of fraud is diminished, and controls are put in place to ensure that key processes can be monitored. SoD helps ensure that no one party has too much power, and that when two or more parties collude to commit fraud, it is detected. Without such oversight, a single party or group could commit fraud, damaging the enterprise and its investors.

Duty segregation follows a pattern that starts with identifying a function that must be performed. This function involves a power that could potentially be abused, and may include such categories as authorization, custody, record keeping, and reconciliation. SoD works to segregate these tasks amongst different individuals in order to reduce the likelihood of fraud. A manager may be assigned to oversee transactions.

According to the example now described, SoD functionality may be implemented in a cloud environment utilizing the HANA in-memory database available from SAP SE. FIG. 3 shows a simplified view of one specific embodiment of an architecture 300 that may be employed in connection with this particular example.

Specifically, a manager 302 may receive from an employee, a request for the employee to take some action. Before granting the employee the authority to take this action, the manager may contact the GRC system through a web browser 304.

In particular, the web browser may access a server 305 of the HANA in-memory database platform 306 as shown. The user may provide via the web browser, user information 308 regarding the identity of the individual employee, together with risk information 309 relating to the action the employee seeks to take. As described below, according to certain embodiments the risk information may further comprise action and permission components.

An Application Program Interface (API) 310 within the database layer, receives the user information and the risk information. FIG. 3A shows details regarding a structure of the API according to an embodiment.

Specifically, a matching engine 320 of the API receives the information, and in turn references a library 322 of stored GRC functions. Here, C++ is used as the programming language for the library, with stored procedures contained in HANA.

In this manner, Dynamic-Link Libraries (DLL) may be made available in the form of GRC Foundation Libraries for consumption. FIGS. 3B 1-3B8 provide an example of computer code written in C++, for performing the method of matching a permission rule to authorizations in order to determine SoD compliance.

While in this particular embodiment the library may comprise C++ code, in other embodiments the functional library may comprise code of a different type (e.g., the specialized ABAP code recognized by the HANA in-memory database and separate application layer(s) designed to interact therewith. FIGS. 3C1-3C8 thus provide an example of computer code written in ABAP for performing the method of FIGS. 3B1-3B8.

Based upon the input information and the library, the matching engine references data in the underlying database 323 and produces a report 324 reflecting issues arising in connection with SoD functionality. In particular, as stated above the report may include indications of specific violations of SoD principles based upon the user information and the risk information.

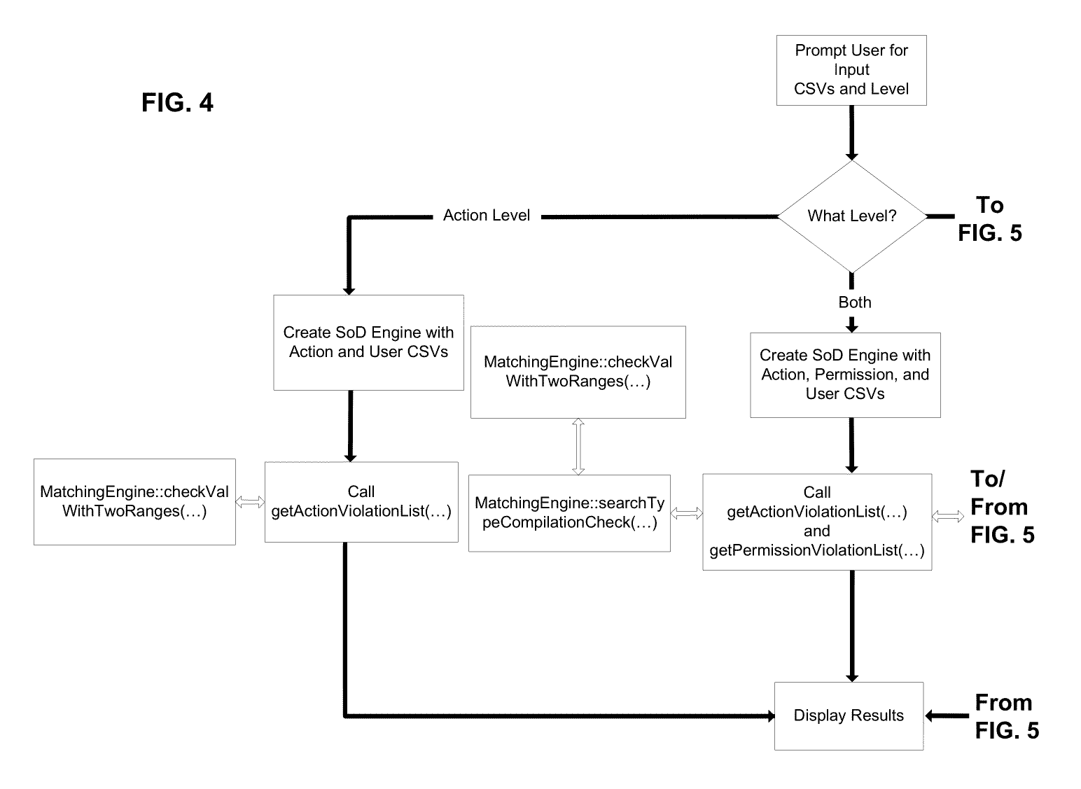

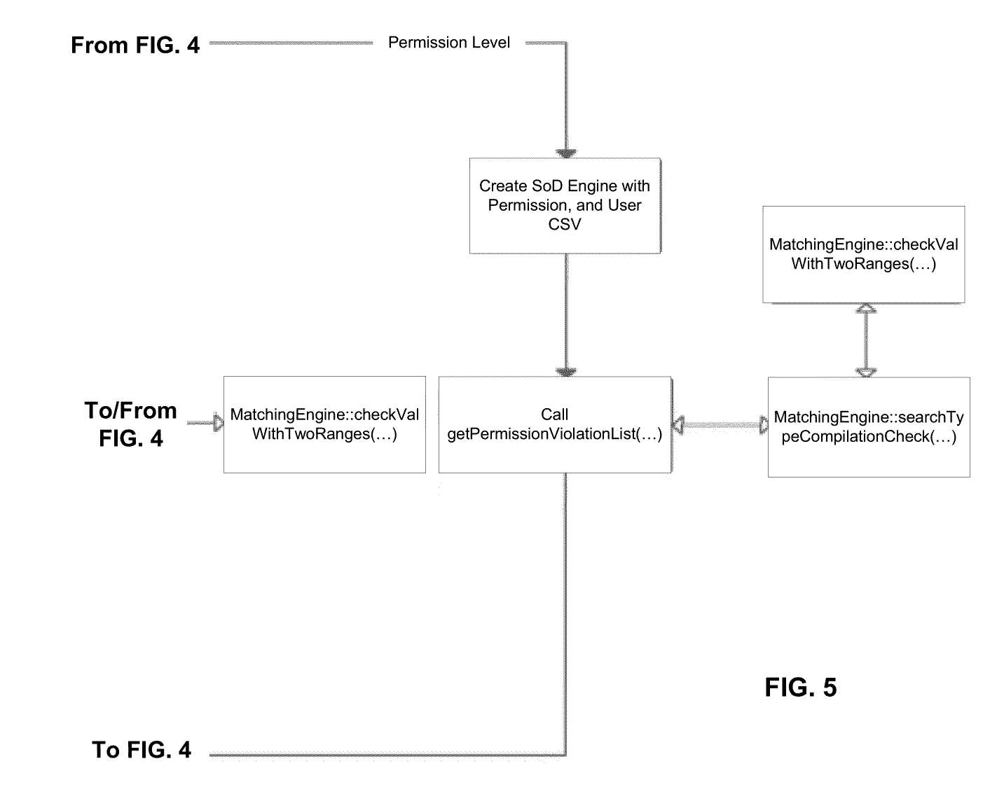

FIGS. 4-5 shows a simplified view of a process flow of a matching engine in this example. Here, an input to the GRC system may select the creation of a report based upon an action level of data in the database, a permission level of data in the database, or both the action level and the permission level. Each of these options are represented by separate pathways in the flow diagram in FIGS. 4-5.

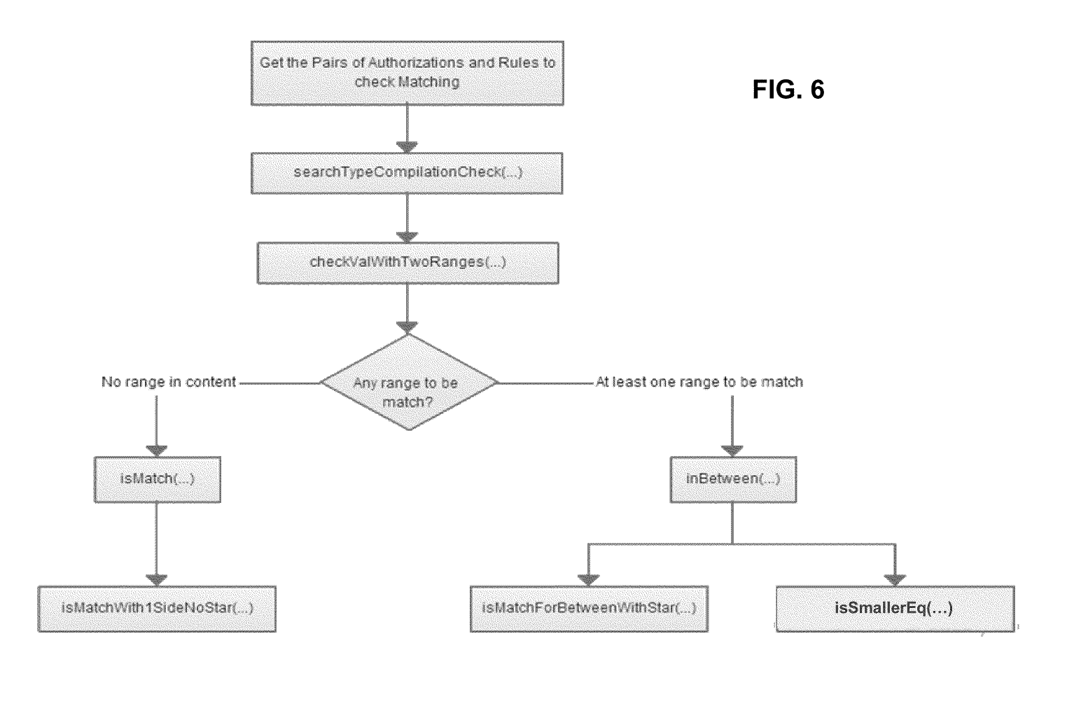

FIG. 6 is a simplified process flow showing additional details regarding application of the functional library for purposes of determining GRC compliance according to this particular embodiment.

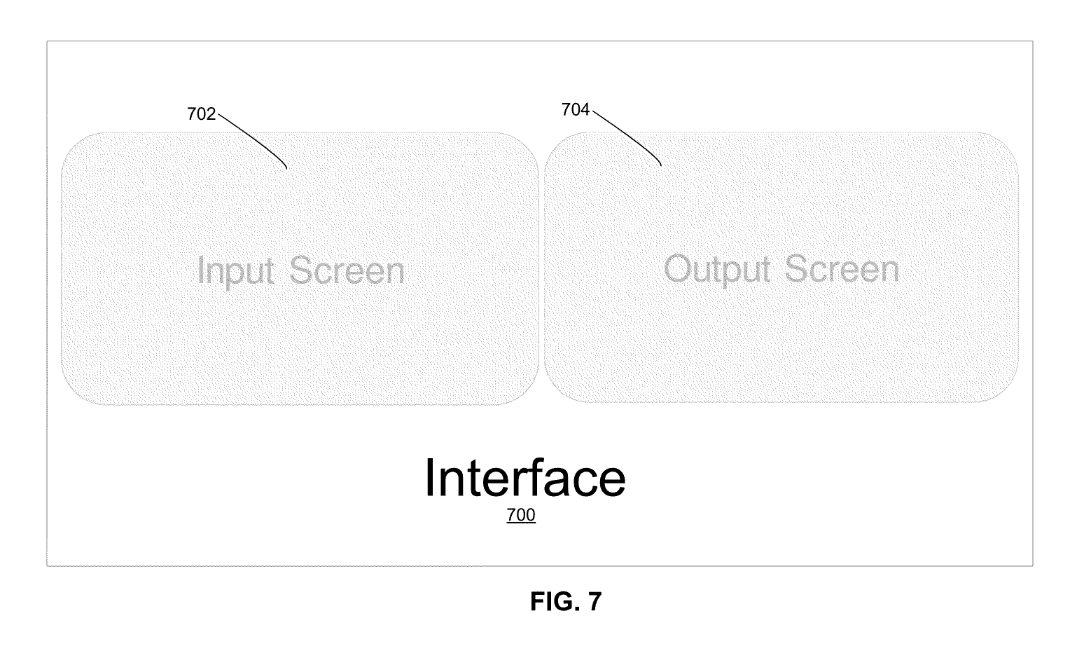

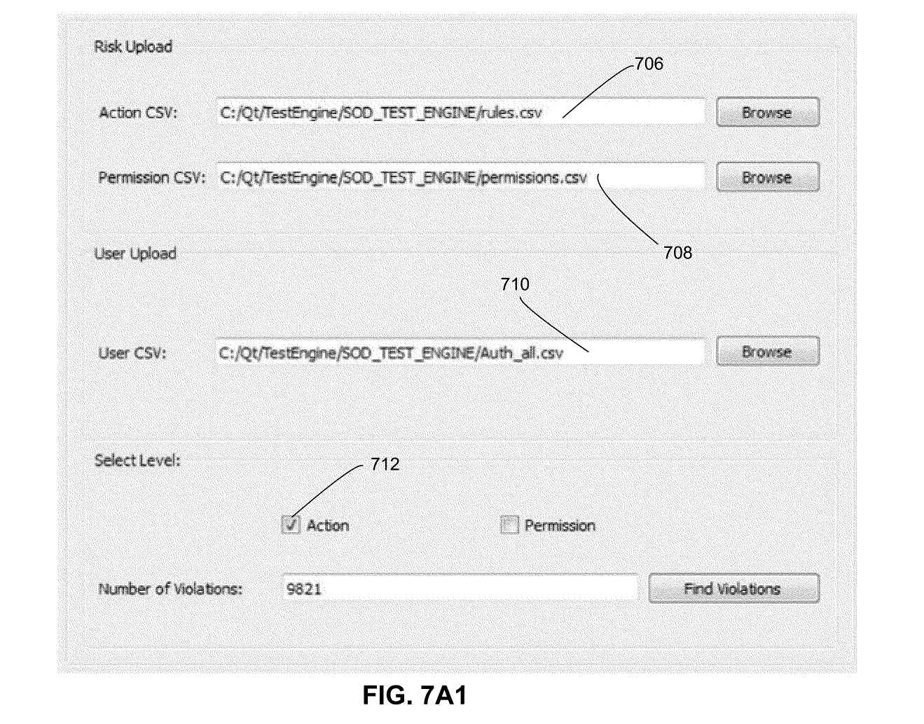

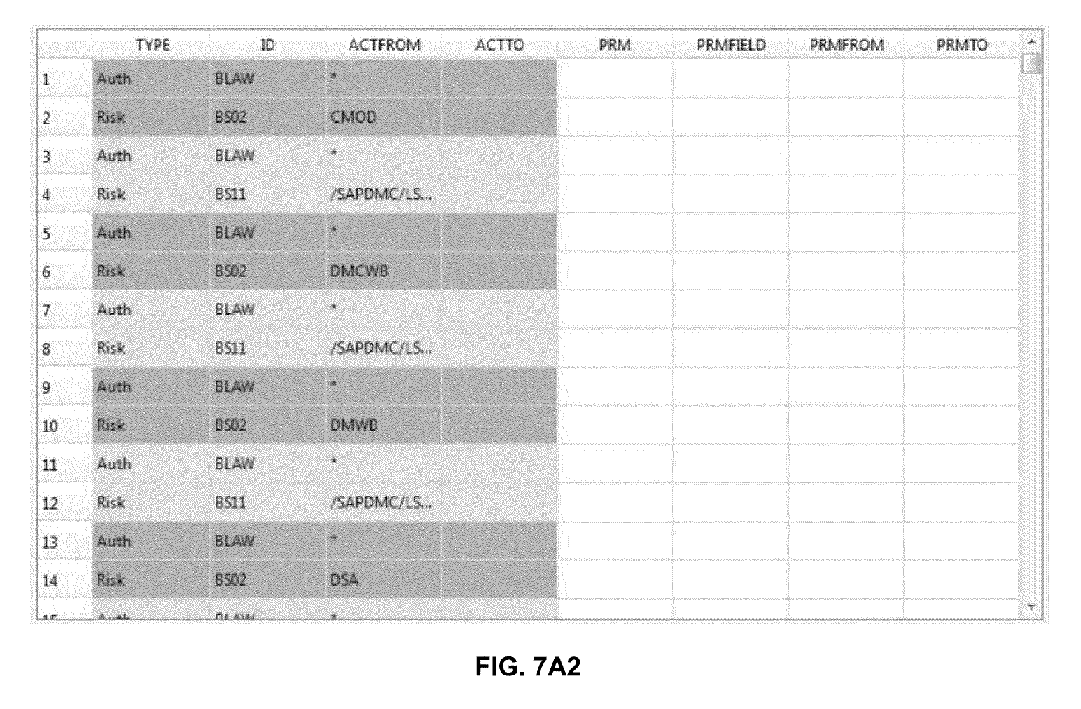

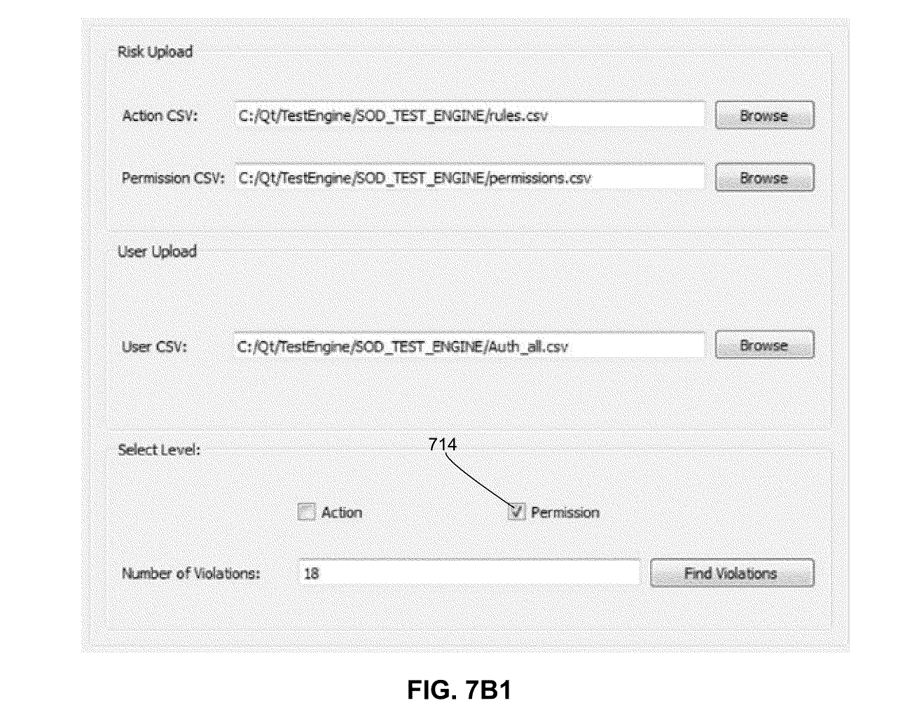

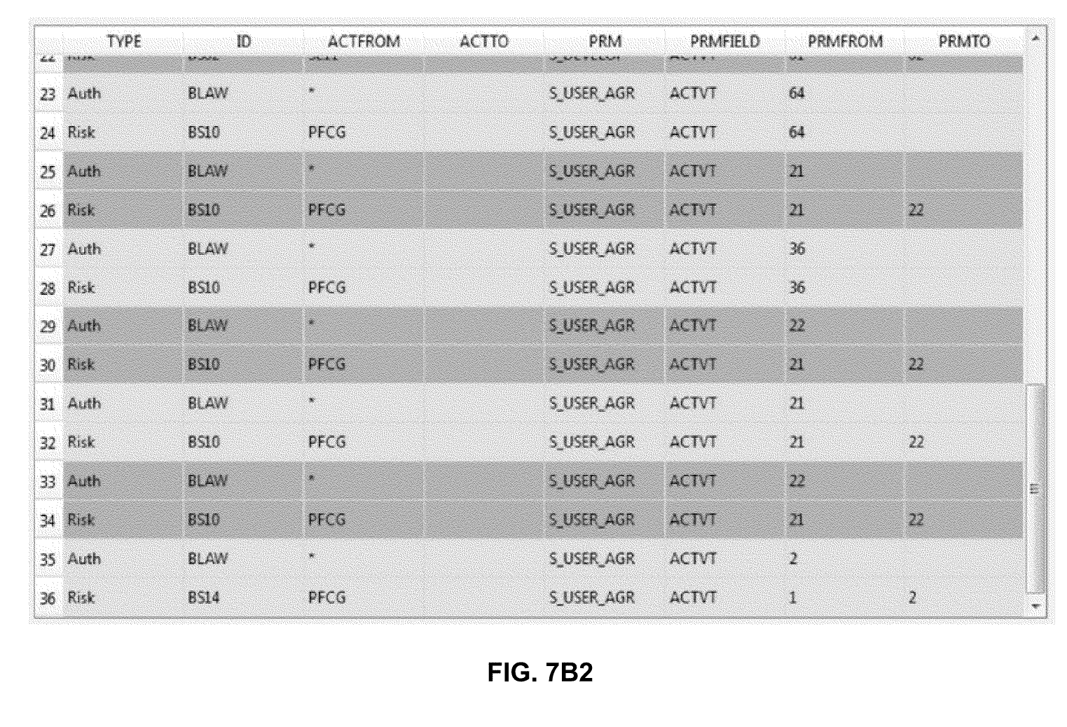

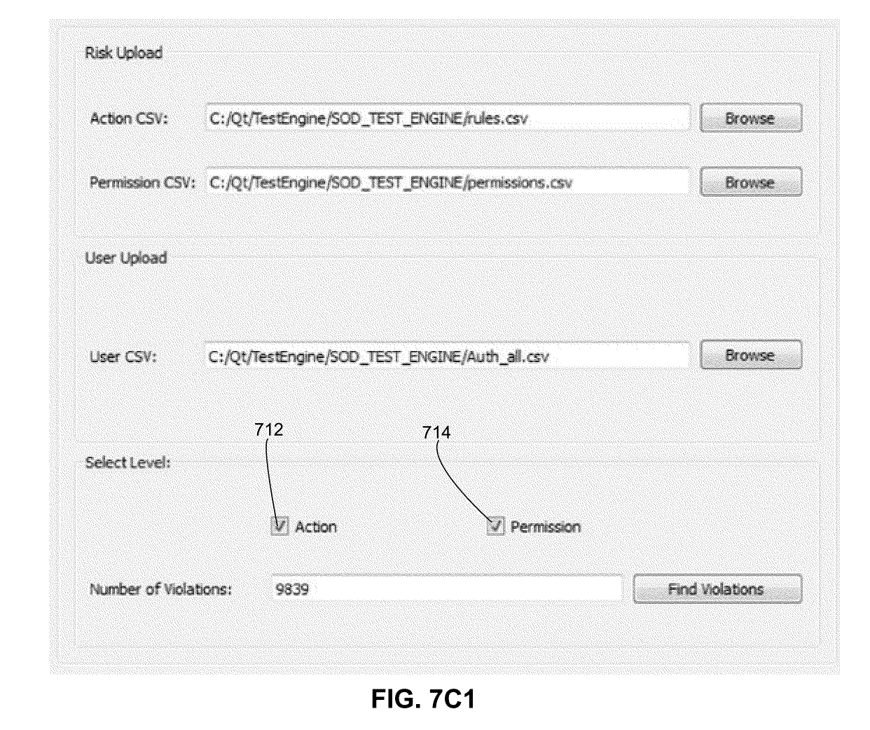

FIGS. 7-7C2 illustrate various aspects of an example of a user interface for a cloud GRC system according to an embodiment. In particular, FIG. 7 shows an interface 700 comprising an input screen 702 and an output screen 704.

FIG. 7A1 shows details of the input screen, including several configured to receive Comma Separated Value (CSV) inputs. The input screen allows uploading SoD risk information 705.

Specifically, the input screen includes an “Action CSV” field 706 indicating that an action has been uploaded. The input screen also includes a “Permission CSV” field 708 indicating the risk permission has been uploaded. The “User CSV” field 710 of the input screen indicates details regarding the user (i.e., the individual whose risk for SoD purposes is being evaluated by the system—not necessarily the “user” who is accessing the server).

The input screen of FIG. 7A1 also allows selecting a GRC rule level. That is, box 712 may be selected to display only individual action level rules.

Accordingly, FIG. 7A2 thus shows the corresponding output screen of the interface where only action risk results are displayed. The columns corresponding to permission (prm) level risk results (e.g., PRM, PRMFIELD, PRMFROM, PRMTO) are not displayed. This output screen displays 9821 SoD violations at the action level only.

Alternatively, the interface allows a user to select the permission level only. The permission indicates the types of internal authorization from a management team that may be required before the action can be taken by the employee.

FIG. 7B1 shows the input screen with the permission box 714 checked. FIG. 7B2 shows the corresponding output screen displaying 18. SoD violations at the permission level only.

Further alternatively, the interface allows selecting both the action and the permission level. Accordingly, FIG. 7C1 shows both boxes 712 and 714 as being checked. FIG. 7C2 shows the corresponding output screen displaying 9839. SoD violations at the Action and Permission level.

To summarize, GRC functionality implemented via the cloud can serve to manage risk posed by employee actions. Access assignments can be automated across various internal software systems, while preventing access violations with embedded risk analysis.

The access control GRC functionality can manage employee roles. Roles that are compliant can be defined and maintained in business-friendly terms and language.

The GRC functionality can allow periodic certification of authorizations. Periodic user-access reviews can be conducted to ensure that SoD mitigations are effective on a regular basis.

The access control GRC functionality can also manage emergency access. Users may be authorized with confidence to perform super-user activities outside their roles, using “firefighter” (emergency) login IDs in a controlled, auditable environment.

While the above example utilizes a function library based upon code in the C++ language, alternative embodiments are possible. Thus, an alternative embodiment utilizing the HANA in-memory database, could be based upon the specialized ABAP code that is utilized by an overlying application layer as a programming language, rather than upon GRC Foundation Libraries of the C++ programming code.

In such alternative approaches, code in the database layer (e.g., as referenced by the matching engine) may be consumed by way of Core Data Services from the application layer. Examples of this can include but are not limited to use of an Open Data Protocol (OData) service, Info Access (InA) tool kit, etc.

And while the above example has discussed implementing cloud-based GRC functionality in the particular HANA in-memory database architecture available from SAP SE, this is not required. Other examples of in-memory databases include but are not limited to the SYBASE IQ database also available from SAP AG; the Microsoft Embedded SQL for C (ESQL/C) database available from Microsoft Corp. of Redmond, Wash.; and the Exalytics In-Memory database available from Oracle Corp. of Redwood Shores, Calif.

Furthermore, while the specific example illustrated above in connection with FIGS. 3-7C2 has illustrated cloud based implementation of access control in connection with SoD, embodiments are not limited to this or any other particular GRC functionality. For example, risk management is another GRC functionality which may be implemented by embodiments of GRC systems as described herein.

Such risk management functionality may include but is not limited to identifying business value drivers. This GRC functionality may permit the alignment of resources, with a focus on value-added processes and activities.

Value creation is another possible attribute provided by GRC risk management. Embodiments may provide insight into factors driving risk to value-added activities and processes, utilizing analytics, visualization, and predictive key risk indicator functionality

GRC risk management approaches may also allow merging of risks and opportunities. Risks and opportunities may be predicted and managed. Responses to same may be analyzed, and enhancement plans and outcomes provided. Responses may be planned and executed with functionality promoting collaboration and streamlining issue management.

GRC functionality implemented on the cloud according to embodiments may also relate to global trade services. For example, embodiments may allow management of most trade regulations, with consideration to localization for more many different countries.

Embodiments may also address import management roles. Such import management may be streamlined with self-filing, importer security filing, duty calculation, and other aspects.

Cloud-implemented global trade services may recognize preferential and free trade agreements. Duty and tax payments may be reduced, and vendor and customer declarations may be managed.

Cloud-implemented global trade services may provide a single repository for data over many jurisdictions. This permits centralizing master, classification, and compliance data.

Cloud-implemented global trade services may also facilitate compliance by different regions and by different industries. Embodiments can automate compliance with processes such as the European Excise Movement and Control System (EMCS).

Fraud detection and management is another GRC functionality that may be implemented according to embodiments. In particular, by eliminating the requirement to access fraud management software solely on-premises, cloud-based GRC functionality may permit detecting fraud earlier and reduction in loss of revenue, together with corresponding investigation of alleged fraud with efficiency and precision. Such embodiments may also facilitate improved decision making in order to prevent fraud.

Process control is yet another type of GRC functionality that may be implemented in a cloud-based environment according to embodiments. Such an application may offer an optimized framework allowing holistic management of controls focused on key risks, materiality, and mandates.

Embodiments may provide multi-compliance support. The cloud-based application is not limited to on-premises infrastructure, and instead may be scaled for expanding requirements and reducing effort via shared controls.

Embodiments may provide continuous monitoring of activities of the enterprise and individual members thereof. Risks and controls may be embedded in key business processes. Control testing may be automated, with monitoring using predefined and configurable rules.

Embodiments may provide for management of content. Such content can be aligned to industry and line of business requirements, incorporating content of the enterprise, specific vendors, and also content of third parties.

Embodiments may provide collaborative workflows, offline forms, and mobile applications. Each of these may in turn enable policy management, control evaluation and sign-off unconstrained by a user's proximity to premises of the enterprise.

Embodiments implementing cloud-based GRC may facilitate efficient issue management. Best-practice workflows, tracking, escalation, and auditing for remediation may be facilitated.

Embodiments may provide for audit management functionality. For example, audits may be streamlined by using technology to create, organize, and share working papers.

The impact of audit activities may be enhanced by using technology in order to provide insight on key business risks. The influence and value of internal audit professionals may be amplified by using next-generation analytics to provide relevant and meaningful advice

Systems and methods implementing GRC functionality in a cloud environment according to embodiments may offer one or more benefits over conventional approaches. For example, such a GRC system offers convenience in that it can be made available online, thus not limiting users to on-premises access.

Another possible benefit is speed of operation and ease of use. In particular, the GRC service can be delivered in the form of a downloadable kit taking a short time to install.

Still another possible advantage offered by embodiments is the limited demand made upon existing resources. That is, the GRC functionality may be based upon a cloud as a service model. Thus it only necessitates use of a particular in-memory database (e.g., HANA), and other elements may be accessed according to their availability.

Moreover, by being available for use as a cloud product, embodiments are by nature a subscription based service that is centrally hosted. They can be accessed as little or as much as demand dictates.

Other potential advantages include low infrastructure costs (managed at a central server), fast responsiveness (again, implemented at the central server), and ease of updatability (e.g., new or supplemented libraries).

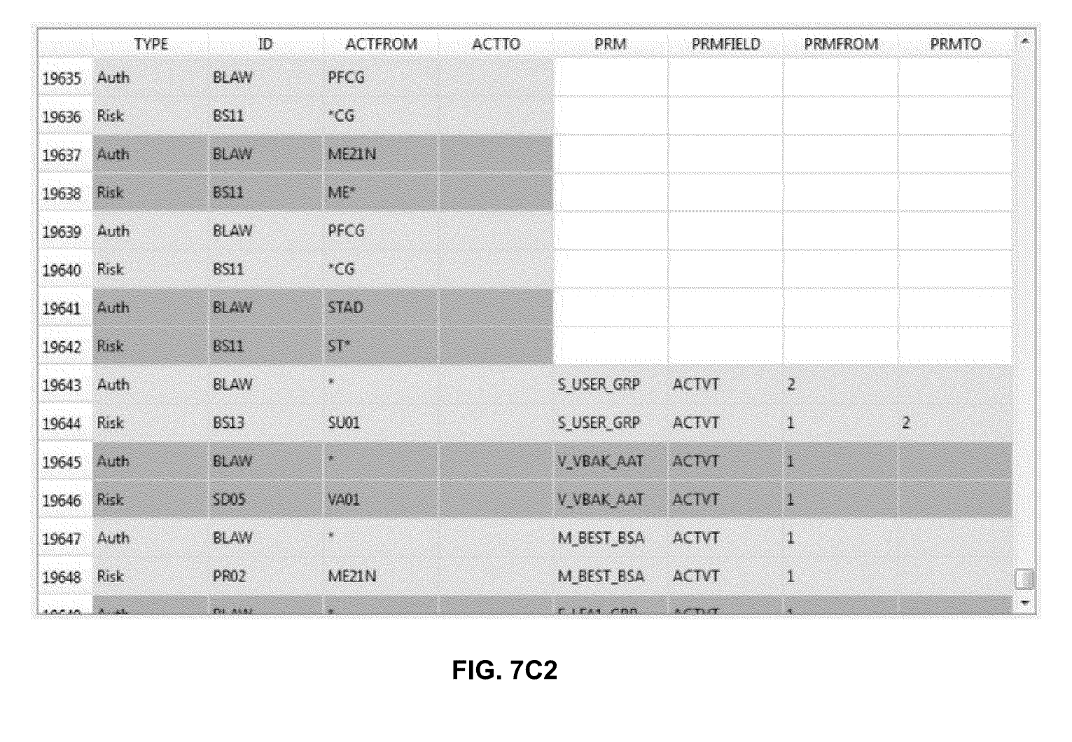

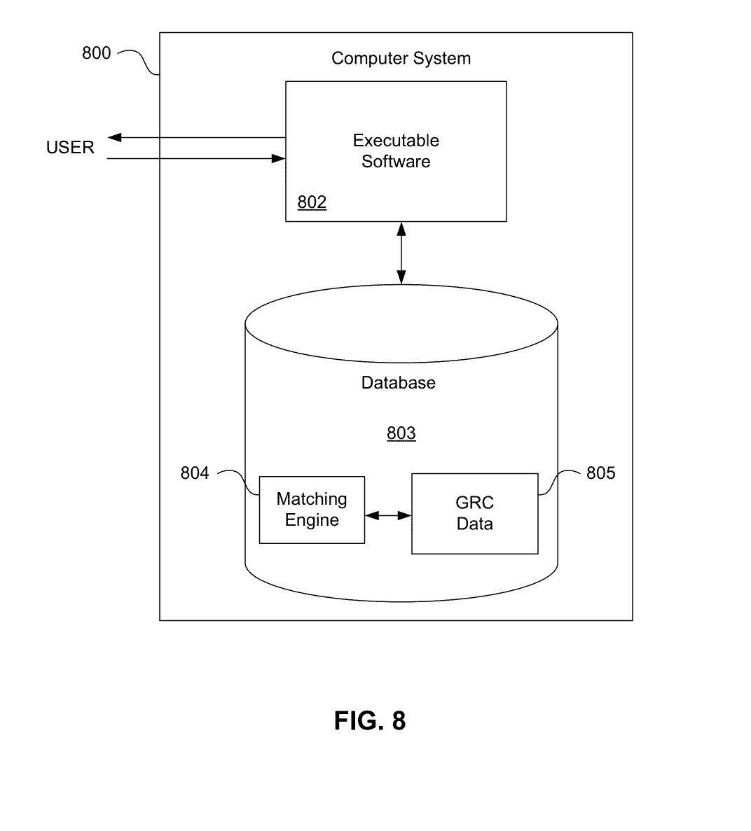

FIG. 8 illustrates hardware of a special purpose computing machine configured to provide GRC functionality according to an embodiment. In particular, computer system 800 comprises a processor 802 that is in electronic communication with a non-transitory computer-readable storage medium 803. This computer-readable storage medium has stored thereon code 805 corresponding to GRC data of an in-memory database. Code 804 corresponds to an in-memory database matching engine configured to execute GRC functionality according to instructions. Code may be configured to reference data stored in a database of a non-transitory computer-readable storage medium, for example as may be present locally or in a remote database server. Software servers together may form a cluster or logical network of computer systems programmed with software programs that communicate with each other and work together in order to process requests.

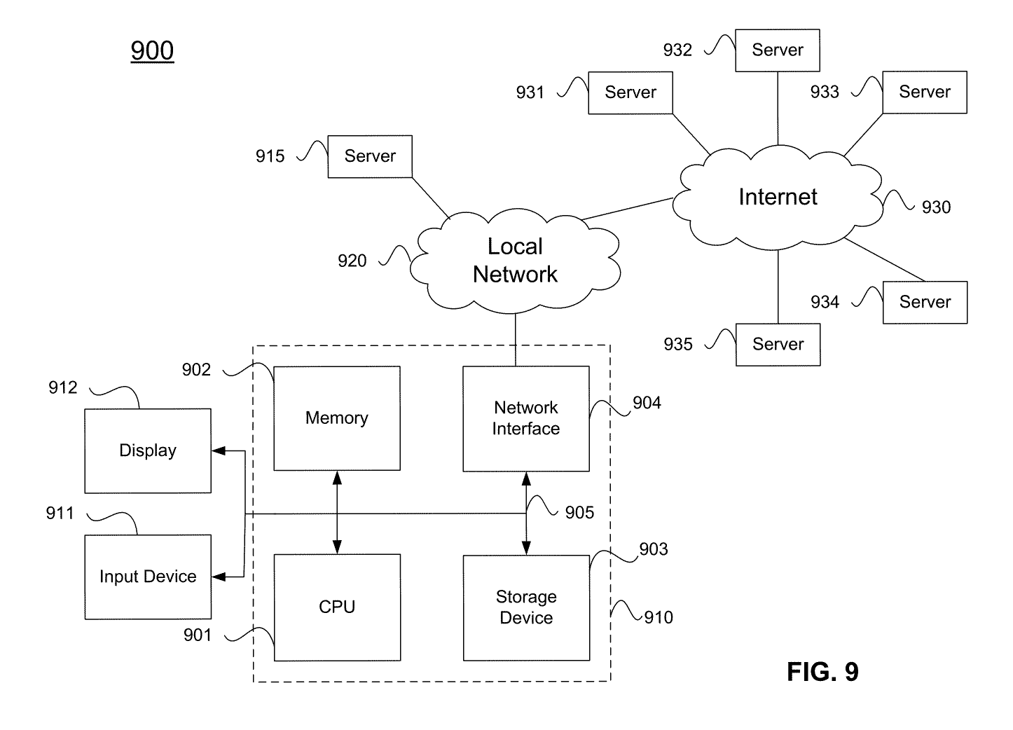

An example computer system 910 is illustrated in FIG. 9. Computer system 910 includes a bus 905 or other communication mechanism for communicating information, and a processor 901 coupled with bus 905 for processing information. Computer system 910 also includes a memory 902 coupled to bus 905 for storing information and instructions to be executed by processor 901, including information and instructions for performing the techniques described above, for example. This memory may also be used for storing variables or other intermediate information during execution of instructions to be executed by processor 901. Possible implementations of this memory may be, but are not limited to, random access memory (RAM), read only memory (ROM), or both. A storage device 903 is also provided for storing information and instructions. Common forms of storage devices include, for example, a hard drive, a magnetic disk, an optical disk, a CD-ROM, a DVD, a flash memory, a USB memory card, or any other medium from which a computer can read. Storage device 903 may include source code, binary code, or software files for performing the techniques above, for example. Storage device and memory are both examples of computer readable mediums.

Computer system 910 may be coupled via bus 905 to a display 912, such as a cathode ray tube (CRT) or liquid crystal display (LCD), for displaying information to a computer user. An input device 911 such as a keyboard and/or mouse is coupled to bus 905 for communicating information and command selections from the user to processor 901. The combination of these components allows the user to communicate with the system. In some systems, bus 905 may be divided into multiple specialized buses.

Computer system 910 also includes a network interface 904 coupled with bus 905. Network interface 904 may provide two-way data communication between computer system 910 and the local network 920. The network interface 904 may be a digital subscriber line (DSL) or a modem to provide data communication connection over a telephone line, for example. Another example of the network interface is a local area network (LAN) card to provide a data communication connection to a compatible LAN. Wireless links are another example. In any such implementation, network interface 904 sends and receives electrical, electromagnetic, or optical signals that carry digital data streams representing various types of information.

Computer system 910 can send and receive information, including messages or other interface actions, through the network interface 904 across a local network 920, an Intranet, or the Internet 930. For a local network, computer system 910 may communicate with a plurality of other computer machines, such as server 915. Accordingly, computer system 910 and server computer systems represented by server 915 may form a cloud computing network, which may be programmed with processes described herein. In the Internet example, software components or services may reside on multiple different computer systems 910 or servers 931-935 across the network. The processes described above may be implemented on one or more servers, for example. A server 931 may transmit actions or messages from one component, through Internet 930, local network 920, and network interface 604 to a component on computer system 910. The software components and processes described above may be implemented on any computer system and send and/or receive information across a network, for example.

The above description illustrates various embodiments of the present invention along with examples of how certain aspects may be implemented. The above examples and embodiments should not be deemed to be the only embodiments, and are presented to illustrate the flexibility and advantages of the present invention as defined by the following claims. Based on the above disclosure and the following claims, other arrangements, embodiments, and implementations may be employed.

What is claimed is:

1. A computer-implemented method comprising:
providing an in-memory database layer comprising a matching engine, a function library, and a database including governance, risk, and compliance (GRC) data;
the matching engine receiving an input regarding an action to be taken by an employee;
the matching engine processing the GRC data according to the input and the functional library to generate a report including a violation; and
causing the in-memory database layer to communicate the report to a web browser.

2. A method as in claim 1 wherein the function library is coded in a language not specific to an application layer configured to interact with an in-memory database layer.

3. A method as in claim 2 wherein the language comprises C++.

4. A method as in claim 1 wherein the function library is coded in a language specific to an application layer configured to interact with the in-memory database layer.

5. A method as in claim 4 wherein the function library causes the matching engine to operate utilizing a function provided by the language.

6. A method as in claim 1 wherein the input comprises risk information and user information.

7. A method as in claim 6 wherein the risk information further comprises an action component and a permission component.

8. A method as in claim 1 wherein the violation comprises a conflict of interest based upon Separation of Duties (SoD).

9. A non-transitory computer readable storage medium embodying a computer program for performing a method, said method comprising:
providing an in-memory database layer comprising a matching engine, a function library, and a database including governance, risk, and compliance (GRC) data;
the matching engine receiving an input regarding an action to be taken by an employee;
the matching engine processing the GRC data according to the input and the functional library to generate a report including a violation; and
causing the in-memory database layer to communicate the report to a web browser.

10. A non-transitory computer readable storage medium as in claim 9 wherein the function library is coded in C++ language not specific to an application layer configured to interact with an in-memory database layer.

11. A non-transitory computer readable storage medium as in claim 9 wherein the function library is coded in a language specific to an application layer configured to interact with the in-memory database layer, and the function library causes the matching engine to operate utilizing a function provided by the language.

12. A non-transitory computer readable storage medium as in claim 9 wherein the input comprises risk information and user information.

13. A non-transitory computer readable storage medium as in claim 12 wherein the risk information further comprises an action component and a permission component.

14. A non-transitory computer readable storage medium as in claim 9 wherein the violation comprises a conflict of interest based upon Separation of Duties (SoD).

15. A computer system comprising:
one or more processors;
a software program, executable on said computer system, the software program configured to:
provide an in-memory database layer comprising a matching engine, a function library, and a database including governance, risk, and compliance (GRC) data;
cause the matching engine to receive an input regarding an action to be taken by an employee;
cause the matching engine to process the GRC data according to the input and the functional library to generate a report including a violation; and
cause the in-memory database layer to communicate the report to a web browser.

16. A computer system as in claim 15 wherein the function library is coded in C++ language not specific to an application layer configured to interact with an in-memory database layer.

17. A computer system as in claim 15 wherein the function library is coded in a language specific to an application layer configured to interact with the in-memory database layer, and the function library causes the matching engine to operate utilizing a function provided by the language.

18. A computer system as in claim 15 wherein the input comprises user information; and risk information.

19. A computer system as in claim 18 wherein the risk information further comprises an action component and a permission component.

20. A computer system as in claim 15 wherein the violation comprises a conflict of interest based upon Separation of Duties (SoD).
